(19) United States
(12) Patent Application Publication
(10) Pub. No.: US 2007/0048582 A1
(43) Pub. Date: Mar. 1, 2007

(54) ALIGNMENT STRUCTURE FOR A PROTON EXCHANGE MEMBRANE FUEL CELL

(76) Inventor: CHIEN-LANG WANG, TAIPEI (TW)

Correspondence Address: G. LINK CO., LTD., 3550 BELL ROAD, MINOOKA, IL, 60447, US

(21) Appl. No.: 11/468,233

(22) Filed: Aug. 29, 2006

(30) Foreign Application Priority Data
Aug. 31, 2005 (TW) 094215049

(51) Int. Cl. H01M 8/02

(52) U.S. Cl. 429/34

(57) ABSTRACT

An alignment structure for a proton exchange membrane fuel cell is disclosed, which is used to accurately position a proton exchange membrane fuel cell onto a fuel cell manufacturing tool. The proton exchange membrane fuel cell comprises a proton exchange membrane and membrane electrode assemblies. The alignment structure comprises first alignment elements and second alignment elements. The first alignment elements are disposed on the proton exchange membrane and in a region other than the membrane electrode assembly. The second alignment elements respectively correspond to the first alignment elements and are disposed on the fuel cell manufacturing tool. Each of the second alignment elements is aligned with a corresponding first alignment element such that the proton exchange membrane fuel cell is placed on the fuel cell manufacturing tool correctly.

### FIELD OF THE INVENTION

The present invention relates to an alignment structure of a proton exchange membrane fuel cell, and more particularly, to an alignment structure respectively disposed on a proton exchange membrane and a fuel cell manufacturing tool, by which a proton exchange membrane fuel cell is positioned on a fuel cell manufacturing tool accurately.

### BACKGROUND OF THE INVENTION

Related prior arts to proton exchange membrane fuel cells almost investigate the modifications and improvements in proton exchange membranes and membrane electrode assemblies. A means to precisely position proton exchange membrane fuel cells onto fuel cell manufacturing tools is still lacking. The fuel cell manufacturing tool may be a fuel cell test device for testing membrane electrode assemblies. Also, the fuel cell manufacturing tool may be a fuel cell assembling device to assembly a proton exchange membrane fuel cell with its components. However, some unpredictable errors are made if a fuel cell manufacturing tool and a proton exchange membrane fuel cell are not positioned and combined correctly.

In view of the importance of accurately positioning proton exchange membrane fuel cells to fuel cell manufacturing tools, an alignment structure is needed to orient the proton exchange membrane fuel cells and fuel cell manufacturing tools.

### SUMMARY OF THE INVENTION

It is a primary object of the invention to provide an alignment structure adapted for a proton exchange membrane fuel cell, by which a proton exchange membrane fuel cell is accurately positioned onto a fuel cell manufacturing tool.

In accordance with the aforementioned object of the invention, an alignment structure for a proton exchange membrane fuel cell is provided, which is used to accurately orient a proton exchange membrane fuel cell to a fuel cell manufacturing tool. The proton exchange membrane fuel cell comprises a proton exchange membrane and at least one above membrane electrode assembly. The alignment structure comprises at least one above first alignment element and at least one above second alignment element. The first alignment elements are disposed on the proton exchange membrane and in a region other than the membrane electrode assemblies. The second alignment elements respectively correspond to the first alignment elements and are disposed on the fuel cell manufacturing tool. Each of the second alignment elements is aligned with a corresponding first alignment element such that the proton exchange membrane fuel cell is placed on the fuel cell manufacturing tool correctly.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a perspective view showing an alignment structure of a proton exchange membrane fuel cell according to an embodiment of the invention;

FIG. 2A is an exploded and cross-sectional view of an alignment structure according to the first embodiment of the invention;

FIG. 2B is a combined and cross-sectional view of the embodiment in FIG. 2A;

FIG. 3 is a plan view of an alignment structure according to the second embodiment of the invention;

FIG. 4 is a plan view of an alignment structure according to the third embodiment of the invention;

FIG. 5 is a plan view of an alignment structure according to the fourth embodiment of the invention; and

FIG. 6 shows an assistant orientation mechanism for an alignment structure according to an embodiment of the invention.

### DETAILED DESCRIPTION OF THE INVENTION

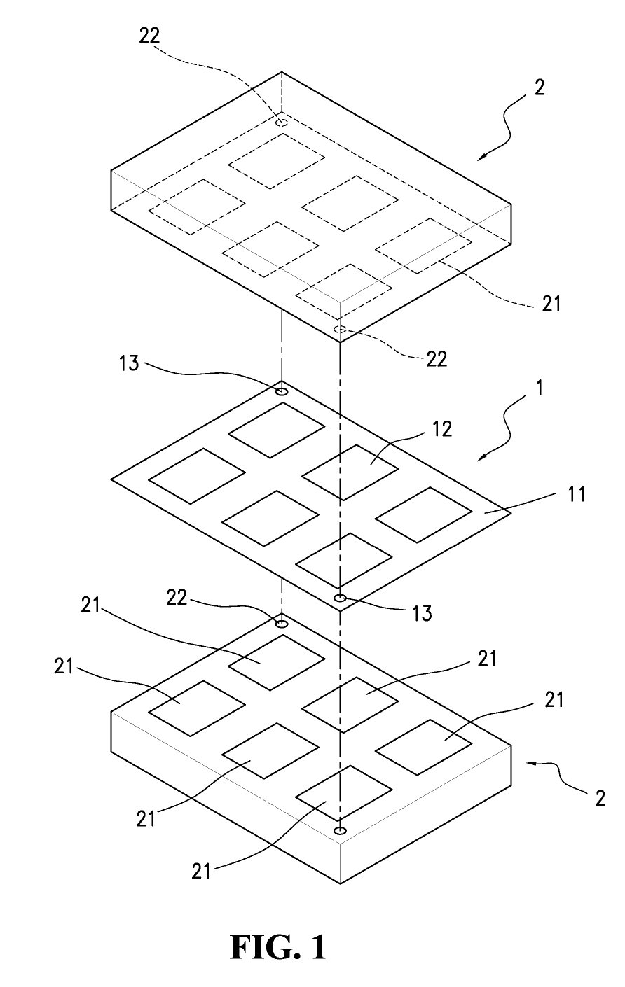

Referring FIG. 1, an alignment structure for a proton exchange membrane fuel cell 1 includes at least one above first alignment elements 13 and at least one above second alignment elements 22; wherein the first alignment elements 13 are placed on a proton exchange membrane 11, while the second alignment elements 22 are placed on a fuel cell manufacturing tool 2. For clarifying the illustrated alignment structure, the number of the first alignment elements 13 or the second alignment elements 22 is one or two (pair) in the descriptions and figures.

The proton exchange membrane fuel cell 1 includes a piece of proton exchange membrane 11 and at least one above membrane electrode assembly (MEA) 12. The area that the MEAs 12 occupy in the proton exchange membrane 11 is regarded as the first region, and the remaining area of the proton exchange membrane 11 is regarded as the second region. The first alignment elements 13 are disposed in the second region.

The fuel cell manufacturing tool 2 is used to process the proton exchange membrane fuel cell 1. For example, the fuel cell manufacturing tool 2 may be a fuel cell test device. Particular environments and fuel supply conditions are provided for the fuel cell 1 through the fuel cell test device 2, so as to test the fuel cell 1. The fuel cell test device 2 has one to several test components 21, and each test component 21 corresponds to one of the MEAs 12 in the proton exchange membrane 11. The fuel cell test device 2 causes the MEAs 12 to perform electrochemical reactions, and meanwhile the test components 21 separately test the MEAs 12.

According to one embodiment of the invention, the area that the test components 21 occupy in the fuel cell manufacturing tool 2 is defined as the third region, while the remaining area of the fuel cell manufacturing tool 2 is defined as the fourth region. The second alignment elements 22 are disposed in the fourth region.

A pair of or several pairs of second alignment elements 22 are placed in the fourth region of the fuel cell manufacturing tool 2, and each pair of second alignment elements 22 is disposed corresponding to a pair of first alignment elements 13. As the fuel cell 1 is placed on the fuel cell manufacturing tool 2, the first alignment elements 13 and the corresponding second alignment elements 22 are aligned with each other such that all of the MEAs 12 of the fuel cell 1 are oriented and positioned accurately onto the corresponding test components 21.

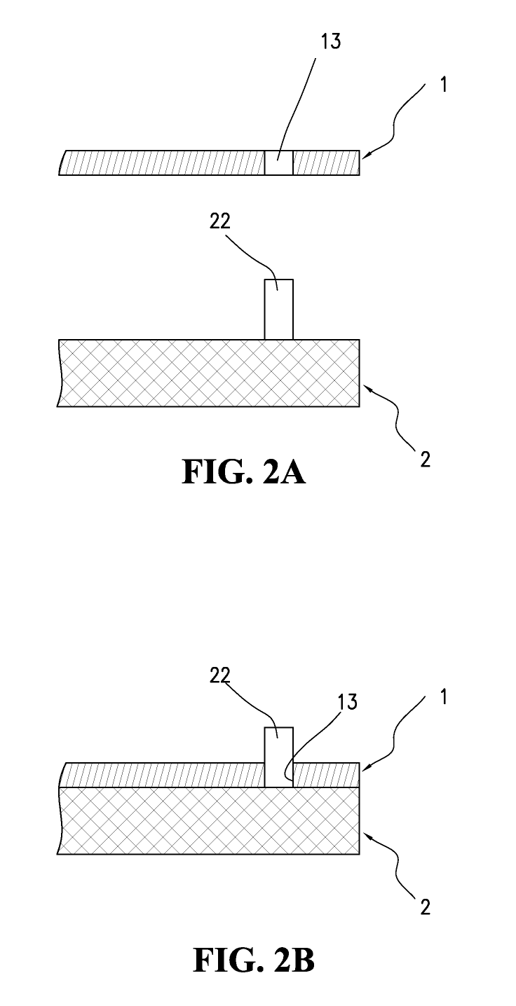

FIG. 2A is an exploded diagram showing an alignment structure according to the first embodiment of the invention. FIG. 2B is a combined view of the embodiment in FIG. 2A. The first alignment element 13 is a through hole penetrating the second region of the proton exchange membrane 11. The second alignment element 22 is a pillar, which protrudes from the fourth region of the fuel cell manufacturing tool 2. The through hole 13 and the pillar 22 are complementary, so that the position can be completed by inserting each of the pillars 22 into each of the through holes 13, respectively, such that all the MEAs 12 of the fuel cell 1 are precisely oriented corresponding to the test components 21.

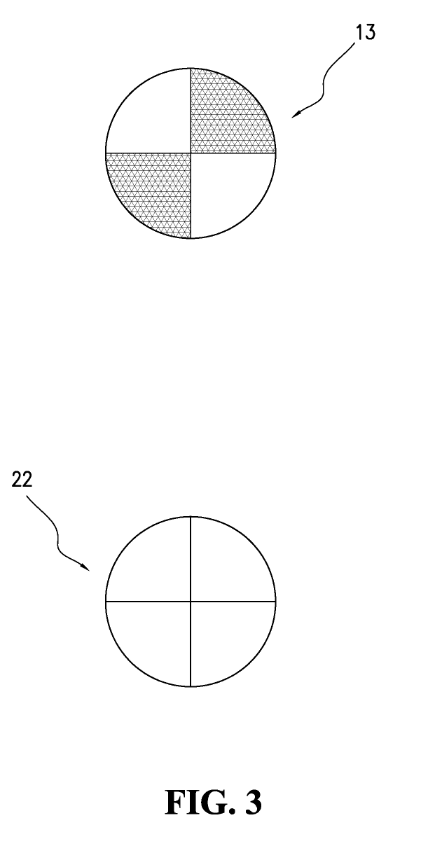

FIG. 3 is a plan view of an alignment structure according to the second embodiment of the invention. The first alignment element 13 is a circular pattern composed of four quadrants. These quadrants are alternating black and white totems. The second alignment element 22 is a circular pattern composed of four quadrants. The circular pattern 13 and the circular pattern 22 correspond to each other and individually include complementary totems corresponding to the alternating black and white totems. As such, the orientation can be completed by overlapping each of the circular patterns 22 and each of the alternating black and white totems of the circular patterns 13, respectively. Thus, all the MEAs 12 of the fuel cell 1 are precisely positioned corresponding to the test components 21.

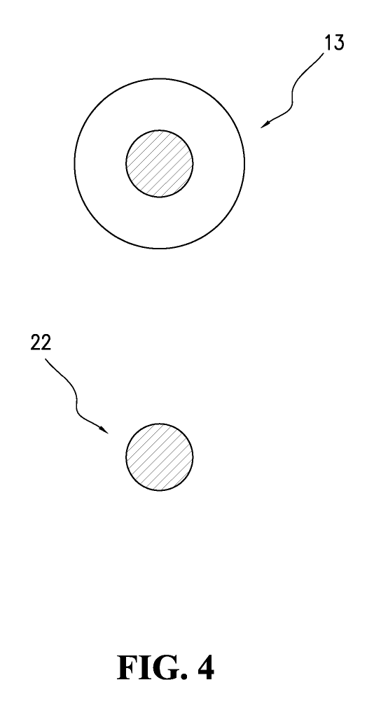

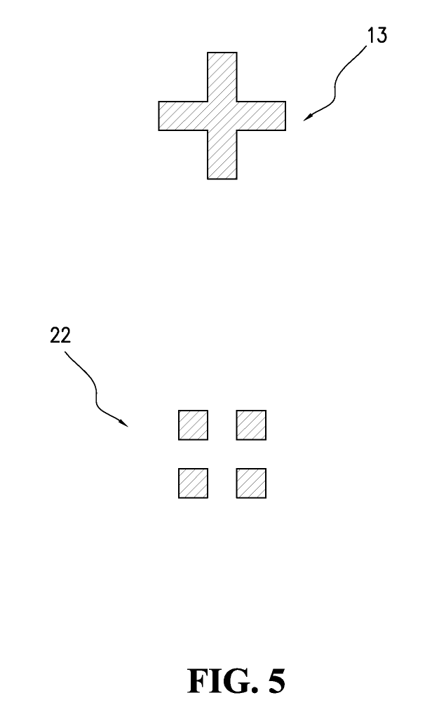

FIG. 4 is a plan view of an alignment structure according to the third embodiment of the invention. FIG. 5 is a plan view of an alignment structure according to the fourth embodiment of the invention. A shown in FIG. 4, the first alignment element 13 is a circular pattern including a dot pattern in its center. The second alignment element 22 is a dot pattern, of which the size is as large as the dot pattern of the first alignment element 13. Referring to FIG. 5, the first alignment element 13 is a cross pattern. The second alignment element 22 is a square pattern, in which the shape and size of the gap in its center are the same as those of the cross pattern of the first alignment element 13.

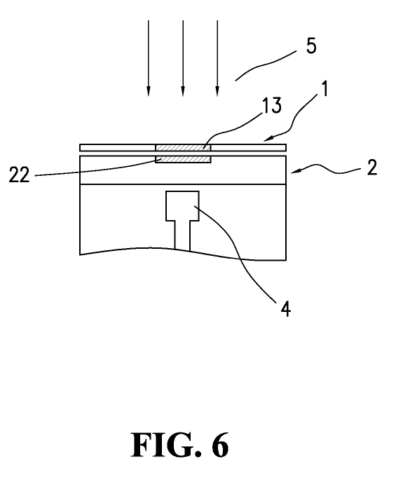

The process of positioning performed by the first to fourth embodiments described above may be inspected directly by eye. Or, an assistant orientation mechanism, such as a photosensitive device 4 with a light source 5, is further attached to the fuel cell manufacturing tool 2 as illustrated in FIG. 6. The light from the light source 5 irradiates the overlap region between the first alignment element 13 and the second alignment element 22. Based on the proportion of overlapping, the photosensitive device 4 detects different signals and determines whether the first alignment element 13 is correctly aligned with the second alignment element 22 according to the intensities of detected signals.

The aforementioned alignment structures are advantageous to position a proton exchange membrane fuel cell onto a fuel cell manufacturing tool accurately, improving the process of testing and assembling for proton exchange membrane fuel cells.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. An alignment structure for a proton exchange membrane fuel cell, which is applied to accurately position a proton exchange membrane fuel cell onto a fuel cell manufacturing tool, wherein the proton exchange membrane fuel cell comprises a proton exchange membrane and at least one above membrane electrode assembly, the alignment structure comprising:
at least one above first alignment element disposed on the proton exchange membrane and in a region other than the membrane electrode assembly; and
at least one above second alignment element each corresponding to the first alignment element, and the second alignment elements are disposed on the fuel cell manufacturing tool,
wherein each of the second alignment elements is aligned with a corresponding first alignment element such that the proton exchange membrane fuel cell is placed on the fuel cell manufacturing tool correctly.

2. The alignment structure of claim 1, wherein a structure of the first alignment element and a structure of the second alignment element are complementary.

3. The alignment structure of claim 2, wherein the first alignment element is a through hole, and the second alignment element is a pillar.

4. The alignment structure of claim 1, wherein the first alignment element and the second alignment element are correspondent and comprise complementary patterns.

5. The alignment structure of claim 4, wherein the first alignment element comprises a circular pattern composed of sectors, wherein the sectors are alternating black and white totems, and the second alignment element comprises a circular pattern corresponding to the sectors.

6. The alignment structure of claim 4, wherein the first alignment element comprises a circular pattern with a dot pattern in a center, and the second alignment element comprises a dot pattern having a size consistent with the size of the dot pattern of the first alignment element.

7. The alignment structure of claim 4, wherein the first alignment element comprises a cross pattern, and the second alignment element comprises a square pattern including a gap in a middle, wherein the gap has a shape and a size consistent with the cross pattern of the first alignment element.

8. The alignment structure of claim 4, wherein the fuel cell manufacturing tool further comprises at least one photosensitive device for receiving light passing through the first alignment element and the second alignment element.
